(19) United States
(12) Patent Application Publication
(10) Pub. No.: US 2009/0323362 A1
(43) Pub. Date: Dec. 31, 2009

(54) SHIELD SYSTEM FOR LAMP MODULE

(75) Inventors: HOU-CHEN LU, Tu-Cheng (TW); KAI HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/238,395

(22) Filed: Sep. 25, 2008

(30) Foreign Application Priority Data
Jun. 30, 2008 (CN) 200810302459.1

(51) Int. Cl. F21V 21/00

(52) U.S. Cl. 362/376

(57) ABSTRACT

A shield system for a lamp module in an electronic device is disclosed. The shield system includes a cover, a mesh sheet and a blocking board. The cover includes an air channel and covers the lamp module. The mesh sheet is attached to the cover and covers the air channel. The blocking board is arranged adjacent to the air channel of the cover and includes a plurality of blades and defines a plurality of air passages.

### BACKGROUND

1. Technical Field

The disclosure relates to lamp systems and, particularly, to a shield system for a lamp module.

2. Description of the Related Art

Most projectors employ a lamp as a light source. The lamps, when burning out, often shatter. Fragments from the shattered lamp may damage other components of the projector, and removal of the fragments from the projector is time-consuming and inconvenient.

Therefore, it is desirable to provide a shield system which can overcome the limitations described.

### BRIEF DESCRIPTION OF THE DRAWINGS

FIG. 1 is an isometric view of a shield system for a lamp module, according to a first exemplary embodiment.

FIG. 2 is an exploded view of the shield system and the lamp module of FIG. 1.

FIG. 3 is an enlarged planar view of the portion III of FIG. 2.

FIG. 4 is an isometric view of a blocking board of the shield system of FIG. 1.

FIG. 5 is an isometric view of a shield system according to a second exemplary embodiment.

### DETAILED DESCRIPTION OF THE EMBODIMENTS

Embodiments of a shield system for a lamp module are described in detail here with reference to the drawings.

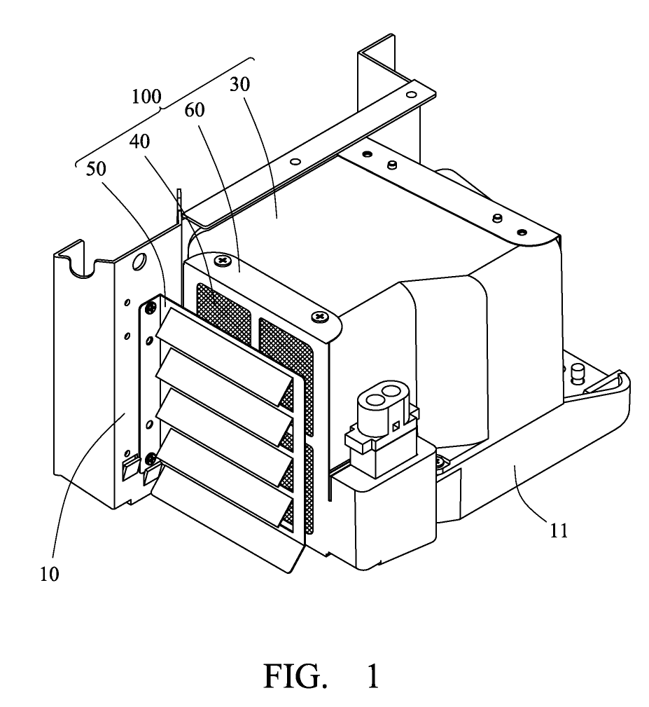

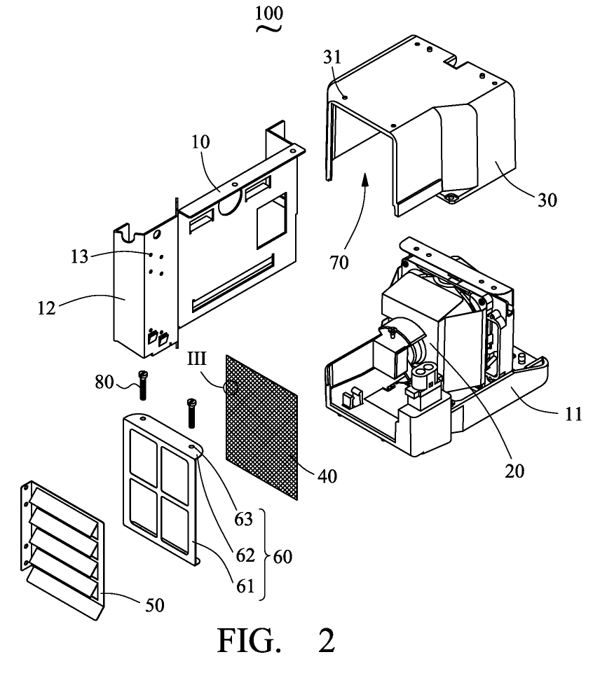

Referring to FIGS. 1 and 2, a shield system 100 for a lamp module 11 for use in a projector 10 blocks fragments of a shattered lamp 20 in the lamp module 11. The shield system 1 00 includes a cover 30, a mesh sheet 40, a blocking board 50 and a frame 60.

The cover 30 covers the lamp module 11 and includes an air channel 70 admitting airflow. In this embodiment, the cover 30 has a cover glass (not shown) covering an exit of the air channel 70 but allowing light transmission therethrough. The other exit of the air channel 70 is closed by the mesh sheet 40. In this embodiment, the mesh sheet 40 is metal. The mesh sheet 40 can be adhered to an inner surface or an outer surface of the cover 30. The frame 60 fixes the mesh sheet 40 to the cover 30. When the mesh sheet 40 is struck by the fragments of the shattered lamp 20, the mesh sheet 40 is supported by the frame 60 to avoid damage and distortion.

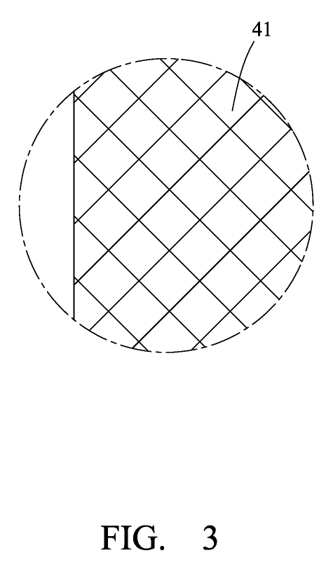

Also referring to FIG. 3, in this embodiment, the mesh sheet 40 is composed of meshes 41 of the same size. Furthermore, the frame 60 includes a border 61 and two lateral arms 62 extending from two opposite sides of the frame 60. In this embodiment, each of the lateral arms 62 defines two through holes 63. The cover 30 defines two threaded holes 31 aligned with the through holes 63 in one of the lateral arms 62. The frame 60 is fixed to the cover 30 by screws 80 passing the through holes 63 and into the threaded holes 31. Alternatively, the frame 60 also can be fixed to the cover 30 by other means, e.g., adhering with glue.

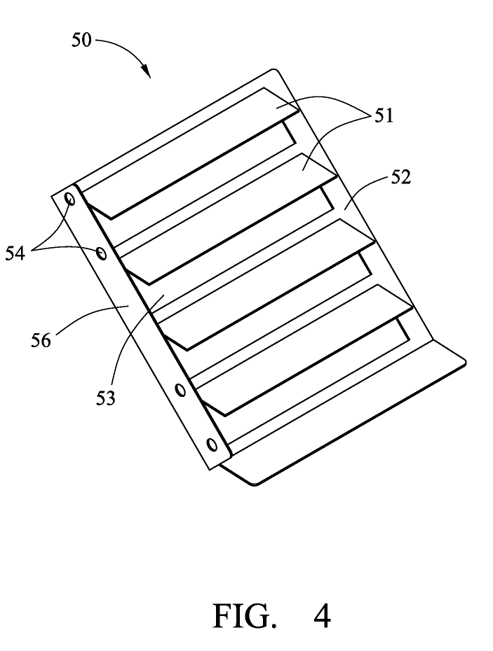

Referring to FIG. 4, the blocking board 50 includes a number of blades 51, a framework 52 for accommodating the blades 51, and a connection element 56. The blades 51 are equidistantly spaced to form air passages 53. The blocking board 50 provides heat dissipation for the lamp module 11. In this embodiment, the blades 51 are parallel to each other and can be fixed to the framework 52 by threading, adhesive, or integral formation. In this embodiment, the blades 51 are integrally formed with the framework 52. The connection element 56 is attached to an edge of the framework 52, substantially perpendicular to the blades 51 and fixed to the cover 30 or other fixture of the projector 10. In this embodiment, the connection element 56 defines a number of through holes 54. The inner side 12 of the projector 10 defines a corresponding number of threaded holes 13 therein. The blocking board 50 is fixed to the inner side 12 of the projector 10 by a corresponding number of screws (not shown) passing through the through holes 54 and into the threaded holes 13 of the inner side 12. Alternatively, the blocking board 50 can be fixed to the inner side 12, by adhering with glue.

The shield system 100 provides the mesh sheet 40 and the blocking board 50 for the lamp module 11. The mesh sheet 40 blocks large fragments from the shattered lamp 20. The blocking board 50 blocks small fragments from the shattered lamp 20. The air passages 53 are, further, capable of dissipating heat generated by the lamp module 11 as an added benefit.

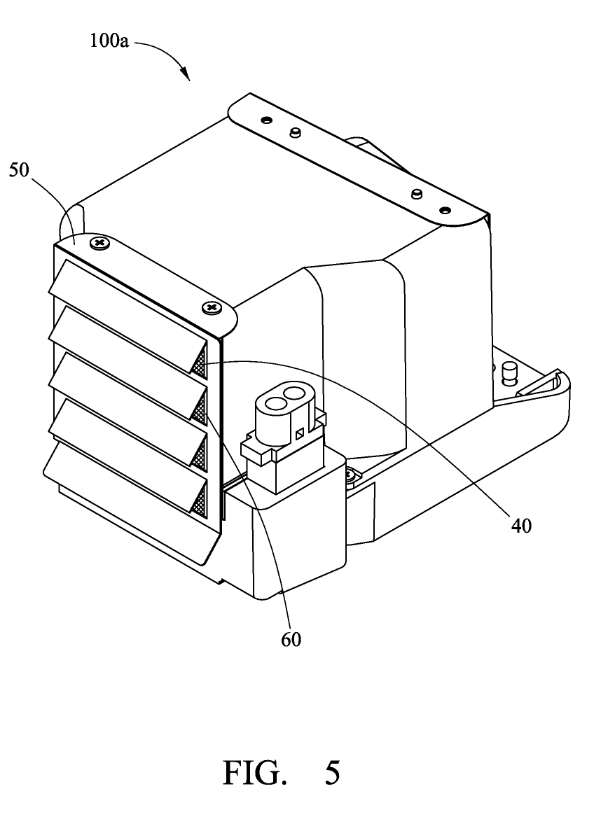

Referring to FIG. 5, a shield system 100a, according to another exemplary embodiment, differs only from shield system 100 in that blocking board 50 is substantially the same size as the frame 60 and is attached thereto. In this embodiment, the mesh sheet 40 is adhered to the frame 60 facing away from the blocking board 50, but can, alternatively, be interposed between the blocking board 50 and the frame 60.

The shield system 100a provides the blocking board 50 attached to the mesh sheet 40 closely. The blocking board 50 blocks bulky and slight fragments from the shattered lamp 20 efficiently.

The shield systems 100 and 100a are capable of collecting the fragments of the shattered lamp 20 therein, easing the burden when cleaning and removing fragments of the shattered lamp 20.

It will be understood that the above particular embodiments are described and shown in the drawings by way of illustration only. The principles and features of the disclosure may be employed in various and numerous embodiments thereof without departing from the scope of the invention as claimed. The above-described embodiments illustrate the scope of the invention but do not restrict the scope of the invention.

What is claimed is:

1. A shield system for a lamp module in an electronic device, comprising:
a cover comprising an air channel and covering the lamp module;
a mesh unit attached to the cover and covering the air channel; and
a blocking board, arranged adjacent to the air channel of the cover, comprising a plurality of blades and defining a plurality of air passages.

2. The shield system of claim 1, wherein the mesh unit is adhered to an inner surface of the cover close to the air channel.

3. The shield system of claim 1, wherein the mesh unit comprises a frame and a mesh sheet attached to the frame, the frame being attached to the cover.

4. The shield system of claim 3, wherein the frame is substantially the same size as the blocking board.

5. The shield system of claim 3, wherein the mesh sheet is metal.

6. The shield system of claim 1, wherein the blocking board is separated from the mesh unit by a space.

7. The shield system of claim 1, wherein the blocking board is adhered to the mesh unit.

8. A shield system for a lamp module in an electronic device, comprising:
a cover comprising an air channel and covering the lamp module; and
a mesh unit attached to the cover and covering the air channel.

9. The shield system of claim 8, wherein the mesh unit is adhered to an inner surface of the cover close to the air channel.

10. The shield system of claim 8, wherein the mesh unit comprises a frame and a mesh sheet attached to the frame, the frame being attached to the cover.

11. The shield system of claim 10, wherein the mesh unit is attached to an inner side of the cover.

12. The shield system of claim 8, further comprising a blocking board, the blocking board being arranged adjacent to the air channel of the cover, and comprising a plurality of blades and defining a plurality of air passages.

13. The shield system of claim 10, wherein the frame is substantially the same size as the blocking board.

14. The shield system of claim 10, wherein the blocking board is separated from the mesh unit by a space.

15. The shield system of claim 8, wherein the blocking board is adhered to the mesh unit.

16. The shield system of claim 10, wherein the mesh sheet is metal.
